(19) United States
(12) Patent Application Publication
(10) Pub. No.: US 2009/0119711 A1
(43) Pub. Date: May 7, 2009

(54) Program recording apparatus and preset condition processing method

(75) Inventor: Takefumi Kitayama, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/283,156

(22) Filed: Sep. 10, 2008

(30) Foreign Application Priority Data
Sep. 14, 2007 (JP) P2007-239854

(51) Int. Cl. H04N 5/445

(52) U.S. Cl. 725/39

(57) ABSTRACT

A program recording apparatus includes an acquiring means, a preset condition storage unit, a determining means, and a notifying means. The acquiring means acquires electronic program guide information. In the preset condition storage unit, a plurality of preset conditions used for retrieving a program from the electronic program guide information acquired by the acquiring means are stored. The determining means determines a preset condition whose recommended level of selection is high out of the plurality of preset conditions stored in the preset condition storage unit on the basis of the electronic program guide information acquired by the acquiring means. The notifying means notifies a user of the preset condition whose recommended level of selection is high determined by the determining means.

### CROSS REFERENCES TO RELATED APPLICATIONS

The present invention contains subject matter related to Japanese Patent Application JP 2007-239854 filed in the Japanese Patent Office on Sep. 14, 2007, the entire contents of which being incorporated herein by reference.

### BACKGROUND OF THE INVENTION

1. Field of the Invention

The present invention relates to a program recording apparatus such as a VTR (Video Tape Recorder) and a preset condition processing method.

2. Description of the Related Art

For example, in a digital terrestrial broadcasting system, for the purpose of informing a viewer of programs provided from respective broadcast stations, data indicating contents of programs which is called electronic program guide information (hereinafter referred to as “EPG (Electronic Program Guide) data”) is periodically delivered from a specific broadcast station. This EPG data is constituted of information including program titles, broadcast dates and times, broadcast channels, program categories, program details, and so on, and serves as a material used for the viewer to determine which program to view. Moreover, the EPG data can be acquired by download from a specific server through the Internet.

A program recording apparatus such as a VTR (Video Tape Recorder) acquires the EPG data, stores it in a memory, and according to a display operation of the viewer, reads this EPG data from the memory and displays it on an external monitor. Thus, the viewer can determine the program to view while looking at the EPG data displayed on the monitor.

Further, there is proposed, for example, a recording apparatus in which the category and keywords of a program suiting a user's preference are previously set as a retrieval condition, and a program matching this retrieval condition within the EPG data is automatically recorded (see Patent Document 1, for example).

### (Patent Document 1)

Japanese Patent Application Laid-Open No. 2003-309787

### SUMMARY OF THE INVENTION

There is proposed a function of previously storing pieces of information on recording conditions (hereinafter referred to as “preset conditions”) in a program ROM or the like of a program recording apparatus, and making a user select, from among the preset conditions, a preset condition that suits the user's preference as a preset condition valid as a recording condition so that a program matching the valid preset condition is retrieved from the EPG data to be presented to the user or a timer recording therefor is automatically set. As the preset conditions, conditions that enable thorough retrieval within the EPG data are used, and thus the user can easily set the recording condition under which omission in retrieval hardly occurs.

For example, when the user selects, from preset conditions such as “new drama program”, “special drama program”, and “new animated program”, “new drama program” as the preset condition suiting his or her own preference, in the program recording apparatus thereafter, programs matching the preset condition “new drama program” are retrieved from the EPG data, and the results of the retrieval are displayed to the user or timer recordings of these programs are set.

However, broadcasts of new programs, special programs, and so on tend to concentrate during a limited period of a year, and therefore, even if preset conditions such as “new drama program”, “special drama program”, and “new animated program” are made valid as the recording conditions during a period other than the period in which the broadcasts are concentrated, programs that match these preset conditions are hardly retrieved. Further, in some cases, the number of preset conditions which can be made valid as the recording conditions is limited to a number smaller than the number of preset conditions prepared in advance so as not to cause any inconvenience to the user due to too many programs being hit. If another new preset condition is requested to be made valid when the limited number of preset conditions are already valid within such a limitation, it is necessary to set any one of the preset conditions already set valid invalid. In this case, however, it is difficult to determine which preset condition can be made invalid.

In view of the above circumstances, it is desirable to provide a program recording apparatus and a preset condition processing method in which a valid preset condition can be easily selected.

According to an embodiment of the present invention, there is provided a program recording apparatus including an acquiring means, a preset condition storage unit, a determining means, and a notifying means. The acquiring means acquires electronic program guide information. In the preset condition storage unit, a plurality of preset conditions used for retrieving a program from the electronic program guide information acquired by the acquiring means are stored. The determining means determines a preset condition whose recommended level of selection is high out of the plurality of preset conditions stored in the preset condition storage unit on the basis of the electronic program guide information acquired by the acquiring means. The notifying means notifies a user of the preset condition whose recommended level of selection is high determined by the determining means.

According to the embodiment of the present invention, by determining the preset condition whose recommended level of selection is high on the basis of the electronic program guide information and notifying the user thereof, the user can easily select a valid preset condition.

In the program recording apparatus according to the embodiment of the present invention, the determining means may count, with respect to the electronic program guide information acquired by the acquiring means, for each of the plurality of preset conditions stored in the preset condition storage unit, the number of programs matching the preset condition, and determine the preset condition as the preset condition whose recommended level of selection is high when the counted value reaches a predetermined value. Consequently, the user can be notified of a preset condition matching many programs as the preset condition whose recommended level of selection is high.

The program recording apparatus according to the embodiment of the present invention may further include a selecting means for causing the user to select a desired preset condition from the plurality of preset conditions stored in the preset condition storage unit, and a program retrieving means for retrieving a program matching the preset condition selected by the user via the selecting means from the electronic program guide information.

Moreover, in the program recording apparatus according to the embodiment of the present invention, the determining means may determine the preset condition whose recommended level of selection is high every time the electronic program guide information is newly acquired by the acquiring means. Consequently, the preset condition whose recommended level of selection is high can be determined at all times on the basis of the latest electronic program guide information.

Further, in the program recording apparatus according to the embodiment of the present invention, the determining means may determine the preset condition whose recommended level of selection is high on the basis of the electronic program guide information acquired by the acquiring means for a given period of time. This makes it possible to judge a period in which programs including specific category and keyword are broadcast in a concentrated manner, and determine the preset condition whose recommended level of selection is high in accordance therewith.

Furthermore, in the program recording apparatus according to the embodiment of the present invention, the notifying means may distinguishably notify the user of the preset condition whose recommended level of selection is high when the selecting means causes the user to select the desired preset condition from the plurality of preset conditions stored in the preset condition storage unit. Thus, the user can select the preset condition to be made valid while being conscious of the preset condition whose recommended level of selection is high.

A preset condition processing method according to another embodiment of the present invention is a preset condition processing method for a program recording apparatus provided with a preset condition storage unit in which a plurality of preset conditions used for retrieving a program from electronic program guide information are stored. The preset condition processing method includes acquiring the electronic program guide information, determining a preset condition whose recommended level of selection is high out of the plurality of preset conditions stored in the preset condition storage unit on the basis of the acquired electronic program guide information, and notifying a user of the determined preset condition whose recommended level of selection is high.

According to the embodiment of the present invention, by determining the preset condition whose recommended level of selection is high on the basis of the electronic program guide information and notifying the user thereof, the user can easily select a valid preset condition.

According to the program recording apparatus and the preset condition processing method of the embodiments of the present invention, it is possible to easily select a valid preset condition.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a configuration of a program recording apparatus as an embodiment of the present invention;

FIG. 2 is a diagram showing an example of preset conditions and internal retrieval conditions stored in a program ROM;

FIG. 3 is a diagram showing an example of a preset condition selection screen;

FIG. 4 is a diagram showing preset condition valid flags;

FIG. 5 is a diagram showing a modified example of the preset condition valid flags;

FIG. 6 is a diagram showing an example of a case where one preset condition is made valid on the preset condition selection screen;

FIGS. 7A to 7C are diagrams each showing an example of program information included in acquired EPG data;

FIG. 8 is a flowchart of processing of determining a preset condition whose recommended level of selection is high and notifying a user of this preset condition;

FIG. 9 is a flowchart of processing of determining a preset condition whose recommended level of selection is high in FIG. 8;

FIG. 10 is a flowchart of processing of notifying the user of the occurrence of a new preset condition whose recommended level of selection is high in FIG. 8; and

FIG. 11 is a diagram showing an example of a popup window for notifying the user of the occurrence of the new preset condition whose recommended level of selection is high.

### DESCRIPTION OF PREFERRED EMBODIMENTS

An embodiment of the present invention will be described in detail below with reference to the drawings.

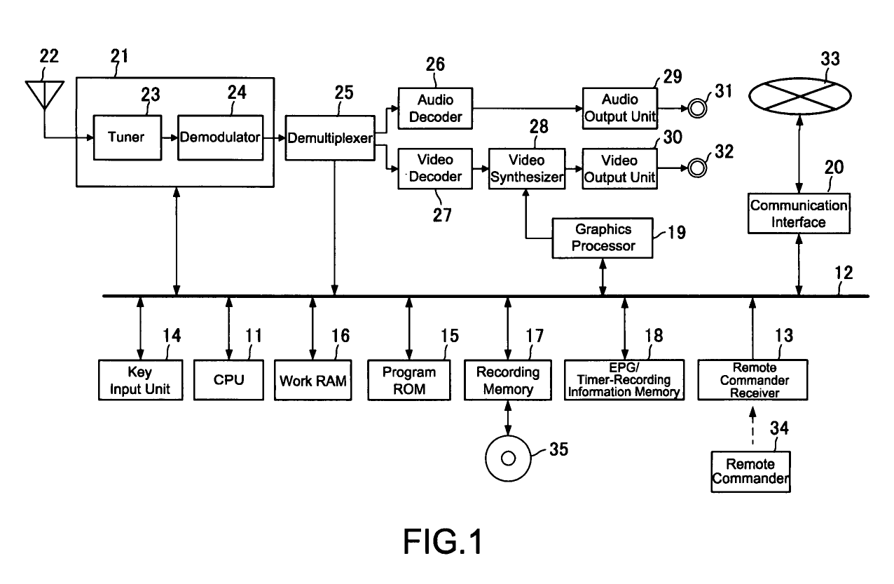

FIG. 1 is a diagram showing a configuration of a program recording apparatus 100 as the embodiment of the present invention. The program recording apparatus 100 is a program recording apparatus for receiving and recording digital terrestrial broadcasting.

The program recording apparatus 100 includes a CPU (Central Processing Unit) 11 serving as a system controller which controls the operation of the entire apparatus. The CPU 11 is connected to a bus 12.

A remote commander receiver 13, a key input unit 14, a program ROM (read only memory) 15, a work RAM (random access memory) 16, a recording memory 17, an EPG/reservation information memory 18, a graphics processor 19, a communication interface 20, a broadcast receiver 21, a demultiplexer 25, and a video synthesizer 28 are also connected to the bus 12.

The remote commander receiver 13 receives a command signal superimposed on infrared rays and transmitted from a remote commander 34, converts this command signal into an electrical command signal, and transmits the electrical command signal to the CPU 11 via the bus 12.

The key input unit 14 has keys corresponding to various command signals and transmits a command signal corresponding to a key operated by a user to the CPU 11 via the bus 12.

The program ROM 15 is a memory in which a control program for controlling the operation of the CPU 11, graphic data and font data for a graphics screen, and other various types of necessary data are stored as much as possible.

The work RAM 16 is a memory used as a working area of the CPU 11 or the like.

The CPU 11 reads the control program stored in the program ROM 15 as necessary, transfers the read control program to the work RAM 16, and develops this control program. The CPU 11 then controls respective units of the program recording apparatus 100 by reading and executing the control program thus developed in the work RAM 16.

The broadcast receiver 21 includes a tuner 23 which takes out a broadcast signal selected on the basis of a tuning signal from the CPU 11, from broadcast waves of a plurality of digital broadcast streams caught by an antenna 22 which receives the broadcast waves of the digital broadcast streams, and a demodulator 24 which demodulates the broadcast signal selected by the tuner 23.

The demultiplexer 25 extracts encoded audio data and encoded video data encoded in MPEG2 from the digital broadcast stream obtained by the demodulator 24, EPG data, and so on. The encoded audio data extracted by the demultiplexer 25 is outputted to an audio decoder 26 connected at a stage subsequent to the demultiplexer 25, and the encoded video data is outputted to a video decoder 27 connected at the stage subsequent to the demultiplexer 25. The encoded audio data obtained by the audio decoder 26 is D/A-converted in an audio output unit 29 and outputted to an audio output terminal 31. On the other hand, the encoded video data obtained by the video decoder 27 is D/A-converted in a video output unit 30 and outputted to a video output terminal 32. The EPG data extracted by the demultiplexer 25 is recorded in the EPG/reservation information memory 18 via the bus 12.

At the time of recording, the digital broadcast stream obtained by the demodulator 24 is transferred to the recording memory 17 via the bus 12 and recorded on a recording medium 35 mounted in the recording memory 17, such as a DVD (Digital Versatile Disc) or an HDD (Hard Disk Drive).

The communication interface 20 is an interface which processes a connection with a network 33 such as the Internet. For example, it is possible that the CPU 11 controls the communication interface 20 to access a server which delivers the EPG data on the network 33 and acquire a file of the EPG data by download.

The EPG/reservation information memory 18 is an area in which the EPG data acquired from the received digital broadcast stream, the EPG data acquired from the network 33, timer-recording information, and so on are stored.

The graphics processor 19 performs drawing processing of graphic screens including a preset condition selection screen and a preset condition recommendation display screen.

The video synthesizer 28 synthesizes the encoded video data obtained by the video decoder 27 and the graphic screen data obtained by the graphics processor 19 and outputs the synthesized data to the video output unit 30.

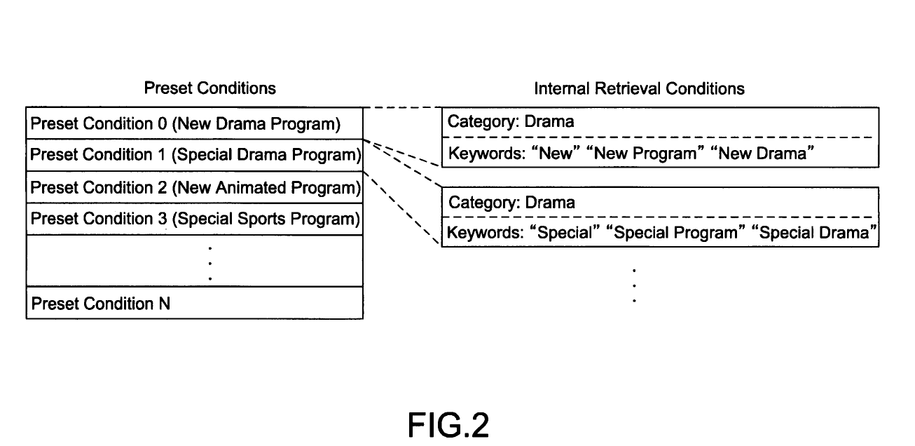

In the program ROM 15, N preset conditions and internal retrieval conditions for retrieving EPG data, which respectively correspond to the preset conditions, are stored in association with each other. FIG. 2 is a diagram showing an example of the preset conditions and the internal retrieval conditions stored in the program ROM 15.

As shown in this figure, in the program ROM 15, as the preset conditions, for example, preset conditions such as “new drama program”, “special drama program”, and “new animated program” are previously stored. Internal retrieval conditions used in the processing of retrieving the EPG data are associated with individual preset conditions. The internal retrieval condition is constituted by a category and a keyword. For example, the category of the internal retrieval condition corresponding to “new drama program” of a preset condition 0 is “drama” and the keywords thereof are “new”, “new program”, and “new drama”.

This program recording apparatus 100 allows the user to select a preset condition suiting his or her own preference from the N preset conditions stored in the program ROM 15 using the remote commander 34 or the key input unit 14 so that this preset condition is made valid.

Next, an operation carried out when the preset condition to be made valid is set will be described.

When detecting that a command to display the preset condition selection screen is inputted by the user using the remote commander 34 or the key input unit 14, the CPU 11 reads the N preset conditions stored in the program ROM 15 and supplies them to the graphics processor 19, and gives a drawing command of the preset condition selection screen to the graphics processor 19. At this time, the CPU 11 gives the drawing command to the graphics processor 19 so that a previously determined preset condition whose recommended level of selection is high is highlighted. Note that the processing of determining the preset condition whose recommended level of selection is high will be described later.

The graphics processor 19 generates preset condition selection screen data on the basis of the drawing command from the CPU 11. The generated preset condition selection screen data is outputted to the video output unit 30 through the video synthesizer 28, D/A-converted in the video output unit 30, and outputted to the video output terminal 32. Thus, the preset condition selection screen is displayed on a TV screen (not shown) connected to the video output terminal 32.

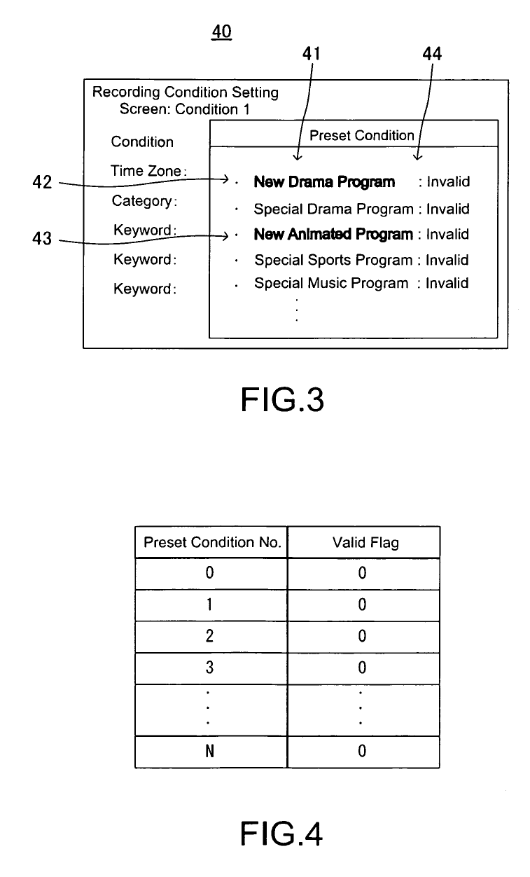

FIG. 3 is a diagram showing an example of this preset condition selection screen 40.

Incidentally, this preset condition selection screen 40 may be provided as, for example, one of recording condition setting screens. FIG. 3 is an example of the preset condition selection screen provided as one of the recording condition setting screens. On the recording condition setting screen, in addition to the preset condition, the time zone, category, keywords, and so on which are specified or inputted directly by the user can be set as the recording conditions. Detailed descriptions thereof will be omitted.

On the preset condition selection screen 40, a list 41 showing N preset conditions read from the program ROM 15 is displayed. Preset conditions 42 and 43 highlighted here are preset conditions previously determined as those whose recommended level of selection is high as described above. In this example, preset conditions of “new drama program” and “new animated program” are highlighted as the preset conditions whose recommended level of selection is high. As a highlighting method, a method of displaying a high-priority preset condition by using different font color and font size, reversed display, italics, or the like so that the condition is distinguishable from other preset conditions is adopted, for example. On the preset condition selection screen, for each preset condition, a character string 44 indicating whether the corresponding preset condition is already set valid (invalid) as the recording condition is displayed.

On this preset condition selection screen 40, the user can select a preset condition suiting his or her own preference out of preset conditions not yet set as the recording conditions and make a setting such that this preset condition is made valid as a recording condition by operating the remote commander 34 or the key input unit 14. At this time, the preset conditions 42 and 43 whose recommended level of selection is high are highlighted, and therefore the user can select a preset condition to be made valid as a recording condition while being conscious of the existence of these preset conditions 42 and 43 whose recommended level of selection is high. When the preset condition to be made valid as the recording condition is set by the user, the CPU 11 sets a valid flag in the work RAM 16 so that this preset condition is made valid.

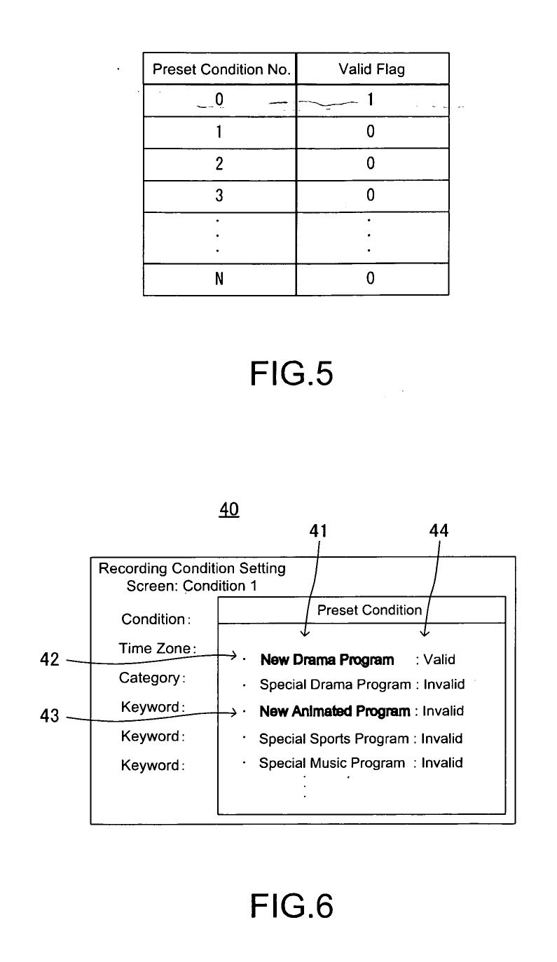

FIG. 4 is a diagram showing preset condition valid flags provided in the work RAM 16. The valid flag is set, that is, “1” is written for the preset condition made valid as the recording condition by the user. For example, when a setting is made such that the preset condition of “new drama program” is made valid as the recording condition by the user on the preset condition selection screen 40 shown in FIG. 3, the valid flag for the preset condition (preset condition No. 0) of “new drama program” is set as shown in FIG. 5.

When controlling the graphics processor 19 so that the preset condition selection screen 40 is displayed, the CPU 11 notifies the graphics processor 19 of the preset condition for which the valid flag is set while referring to the preset condition valid flags provided in the work RAM 16. Thus, it is possible to display whether each of the preset conditions displayed on the preset condition selection screen 40 is already set as the recording condition. For example, when the valid flags of the respective preset conditions are set as shown in FIG. 5, the preset condition of “new drama program” is changed to the character string 44 of “valid” from “invalid”, as shown in FIG. 6.

By repeating the above operation, a total of M preset conditions can be made valid as the recording conditions. Here, M is a value smaller than the number (N) of preset conditions stored in the program ROM 15. If another new preset condition is set as valid when M preset conditions are already valid, the valid flag for the oldest valid preset condition, the preset condition selected by the user, or the like is reset, for example.

Next, an operation of retrieving a relevant program from the EPG data according to the internal retrieval condition corresponding to the valid preset condition set by the user as described above will be described.

First, the acquisition of the EPG data to be searched will be described. Examples of a method of acquiring the EPG data include a method of acquiring the EPG data by demultiplexing the EPG data multiplexed into the digital broadcast stream, a method of acquiring the EPG data by accessing the server which delivers the EPG data on the network 33 and downloading the file of the EPG data, and so on, but the present invention is not limited to these methods of acquiring the EPG data.

The acquired EPG data is recorded in the EPG/reservation information memory 18, and the CPU 11 retrieves a program matching the internal retrieval condition corresponding to the valid preset condition while referring to the latest EPG data recorded in the EPG/reservation information memory 18. The CPU 11 extracts information necessary for timer-recording (timer-recording information) a program matching the internal retrieval condition from the EPG data and stores it in the EPG/reservation information memory 18. After that, the CPU 11 performs automatic recording processing of the program on the basis of the timer-recording information stored in the EPG/reservation information memory 18. Alternatively, the CPU 11 notifies the user through the TV screen that the program matching the internal retrieval condition corresponding to the valid preset condition has been retrieved, to thus allow the user to select whether the timer recording is to be set. When it is selected by the user that the timer recording is to be set, the CPU 11 makes the relevant timer-recording information stored in the EPG/reservation information memory 18 valid to perform the automatic recording processing of the program on the basis of the timer-recording information. It is also possible that after the timer-recording information is stored in the EPG/reservation information memory 18 as described above, the user arbitrarily makes a switch by mode setting between a mode in which the automatic recording processing of the program is performed without asking for a permission of the user and a mode in which the automatic recording processing of the program is performed after asking for a permission of the user.

Next, a specific operation that is carried out when the program matching the internal retrieval condition corresponding to the valid preset condition is retrieved from the EPG data will be described.

The valid preset condition is assumed to be “new drama program”. As for the internal retrieval condition corresponding to the preset condition of “new drama program”, as shown in FIG. 2, the category is “drama”, and the keywords are “new”, “new program”, and “new drama”.

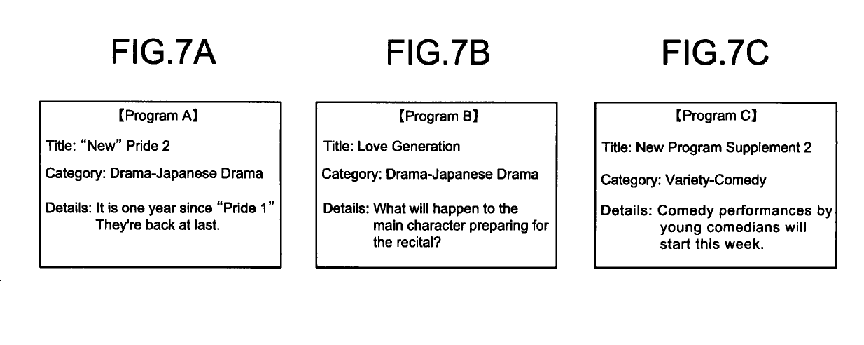

FIG. 7 show an example of the latest acquired EPG data. Generally, the EPG data is constituted of information including program titles, broadcast dates and times, broadcast channels, program categories, program details, and so on, but information that is to be matched with the internal retrieval condition of the preset condition is, for example, a program title, a program category, a program detail, or the like.

In matching processing between the internal retrieval condition of the preset condition and the EPG data, a program whose information matches the category of the internal retrieval condition and matches any one of the keywords of the internal retrieval condition is regarded as a program matching the preset condition. Hence, assuming that information on programs A, B, and C respectively shown in FIGS. 7A to 7C is an object to be retrieved, the category of the program A in FIG. 7A is “drama-Japanese drama” which matches the category “drama” of the internal retrieval condition corresponding to the preset condition, the title of the program A is ““New” Pride 2” which matches one of the keywords “new” of the internal retrieval condition corresponding to the preset condition, and therefore this program A is determined to be the program matching the preset condition. The category of the program B in FIG. 7B is “drama-Japanese drama” which matches the category “drama” of the internal retrieval condition corresponding to the preset condition, but the title of the program B is “Love Generation” which does not match any of the keywords of the internal retrieval condition corresponding to the preset condition, and therefore this program B is determined to be the program not matching the preset condition. Although the title of the program C is “New Program Supplement 2” which matches one of the keywords “new” of the internal retrieval condition corresponding to the preset condition, the category of the program C in FIG. 7C is “variety-comedy” which does not match the category “drama” of the internal retrieval condition corresponding to the preset condition, and therefore this program C is determined to be the program not matching the preset condition.

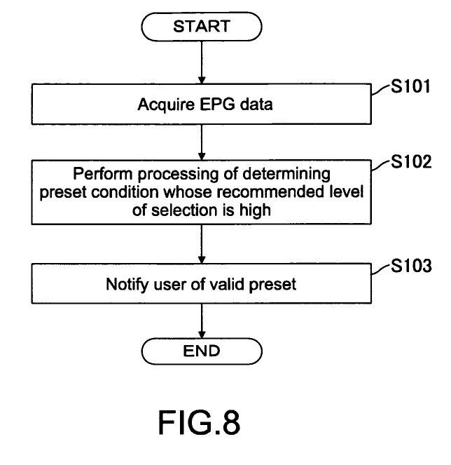

Next, the processing of determining a preset condition whose recommended level of selection is high and notifying the user of this preset condition will be described. FIG. 8 is a flowchart showing a main routine of this processing.

Here, the preset condition whose recommended level of selection is high refers to a preset condition with which, when the number of broadcast programs matching the preset condition increases seasonally, many programs matching this preset condition can be retrieved if this preset condition is made valid. For example, new broadcast programs start during a specific period of a year in a concentrated manner, and broadcast programs of various events such as the Olympics are broadcast intensively during a specific period.

Hence, as shown in FIG. 8, every time the latest EPG data is acquired (step S101), the CPU 11 counts, for each of the preset conditions stored in the program ROM 15, the number of programs matching the preset condition, determines the preset condition as the preset condition whose recommended level of selection is high if the number of programs matching this preset condition reaches a set value (step S102), and invites the user's attention by notifying the user of the occurrence of the new preset condition whose recommended level of selection is high by using a popup window, or highlighting the preset condition whose recommended level of selection is high on the preset condition selection screen 40 (step S103).

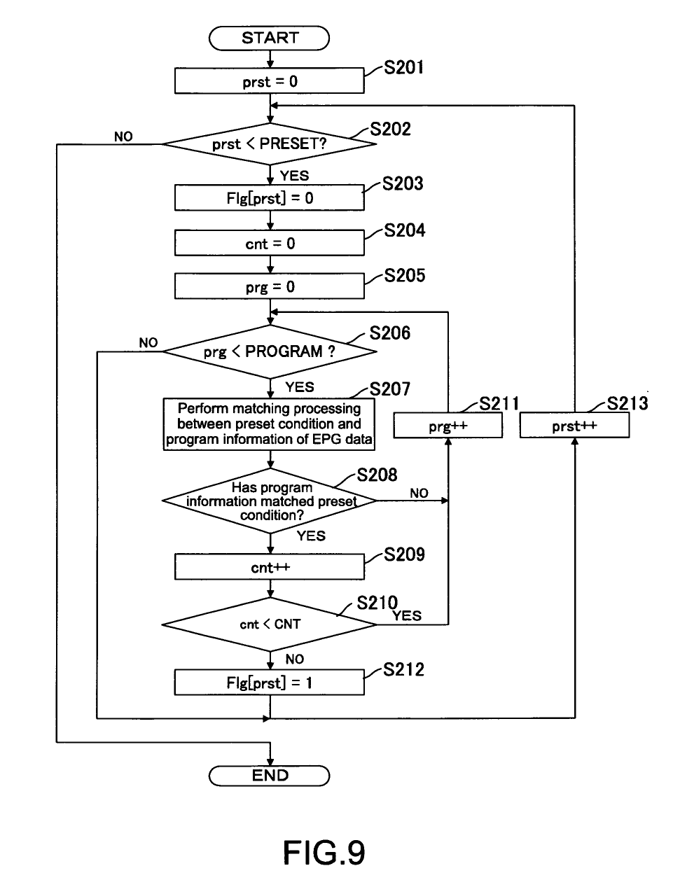

Next, details of the processing of determining the preset condition whose recommended level of selection is high (step S102) will be described. FIG. 9 is a flowchart of this processing.

Variables will be defined as follows.

prst: counter for counting the number of preset conditions in the program ROM 15 used for the retrieval

Flg[prst]: flag indicating whether or not the preset condition [prst] is the preset condition whose recommended level of selection is high

PRESET: number of all preset conditions in the program ROM 15

cnt: counter for counting the number of programs matching the preset condition

prg: counter for counting the number of researched programs

PROGRAM: total number of programs in the EPG data

CNT: threshold value of the number of programs matching the preset condition, which is used to judge whether the user should be notified

The CPU 11 performs the following processing in accordance with the control program stored in the program ROM 15. First, the CPU 11 initializes the prst counter, the Flg[prst] flag, the cnt counter, and the prg counter as initialization processing in step S201 to step S205.

Then, the CPU 11 performs matching processing between the first preset condition and the first program information of the EPG data (step S207). This matching processing is the same as the matching processing carried out when the program matching the internal retrieval condition corresponding to the valid preset condition is retrieved from the EPG data. The CPU 11 increments the value of the cnt counter when the program information matches the preset condition in this matching processing (step S209), determines whether the value of the cnt counter has reached CNT (step S210), increments the value of the prg counter when it is determined that the value of the cnt counter has reached CNT (step S211), and uses the next program information of the EPG data as an object to be matched to the preset condition. On the other hand, also when it is determined that the program information does not match the preset condition in step S207, the CPU 11 increments the value of the prg counter (step S211) and uses the next program information of the EPG data as the object to be matched to the preset condition.

The CPU 11 repeats the above processing from step S207 to step S211, and when the value of the cnt counter indicating the number of pieces of program information matching the preset condition reaches CNT before the matching processing between the first preset condition and all pieces of program information in the EPG data ends, the Flg[prst] flag is set to set this preset condition as the preset condition whose recommended level of selection is high (step S212).

Further, when the value of the prg counter exceeds PROGRAM without the value of the cnt counter indicating the number of program information matching the preset condition reaching CNT during the repetition of the above processing from step S207 to step S211, that is, the matching processing between the first preset condition and all the pieces of program information in the EPG data has ended (NO in step S206), the CPU 11 increments the prst counter without setting the Flg[prst] flag for the first preset condition (step S213) and changes the object to be matched with the program information to the next preset condition. Then, the CPU 11 performs the processing of the initialization of the Flg[prst] flag for the preset condition and the processing thereafter (step S203) in the same manner and determines whether to set this preset condition as the preset condition whose recommended level of selection is high.

After incrementing the prst counter, the CPU 11 compares the value of the prst counter and PRESET to determine whether the matching processing with the program information of all the preset conditions stored in the program ROM 15 is completed, and when the matching processing with the program information of all the preset conditions is completed (NO in step S202), ends the processing of determining the preset condition whose recommended level of selection is high.

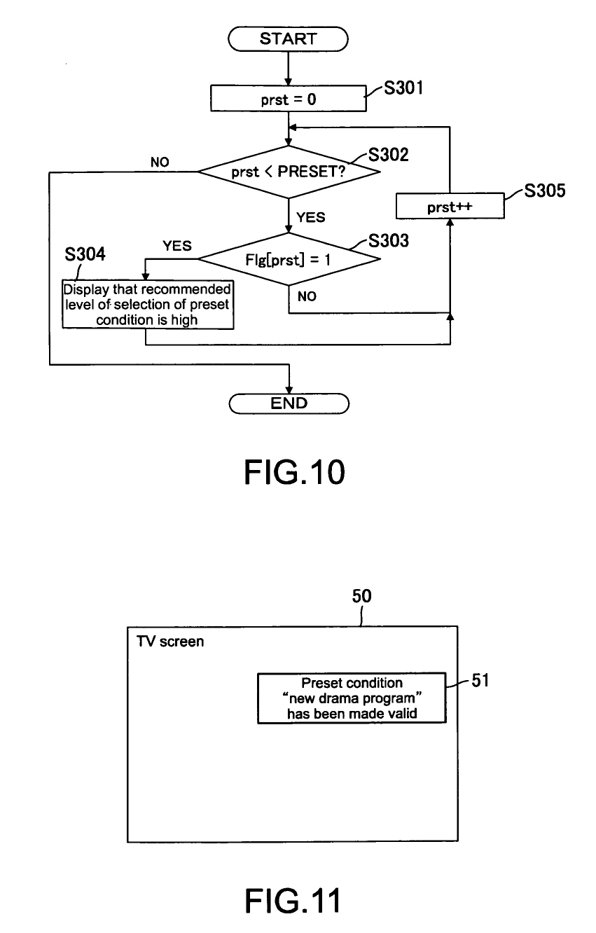

Next, details of the processing of notifying the user of the occurrence of the new preset condition whose recommended level of selection is high (step S103) will be described. FIG. 10 is a flowchart of this processing.

The CPU 11 performs the processing in accordance with the control program stored in the program ROM 15 in the following manner. First, the CPU 11 initializes the prst counter as initialization processing (step S301). Then, the CPU 11 determines whether the Flg[prst] flag for the first preset condition is set (step S302), and when the Flg[prst] flag is set, the CPU 11 notifies the user that this preset condition is the preset condition whose recommended level of selection is high (step S304). When the Flg[prst] flag is not set, the CPU 11 increments the prst counter (step S305) and uses the Flg[prst] flag for the next preset condition as an object to be checked. The CPU 11 repeats the above processing for all the preset conditions stored in the program ROM 15, and ends the processing when checking of the Flg[prst] flags for all the preset conditions is completed (YES in step S302).

FIG. 11 is a diagram showing an example of a popup window for notifying the user of the occurrence of the new preset condition whose recommended level of selection is high. When the new preset condition whose recommended level of selection is high occurs, the CPU 11 transmits a drawing command of the popup window including information on the newly-occurred preset condition whose recommended level of selection is high to the graphics processor 19. The graphics processor 19 generates data on the popup window according to this drawing command and outputs this data to the video output unit 30 via the video synthesizer 28.

Thus, as shown in FIG. 11, a popup window 51 into which a message indicating the occurrence of the new preset condition whose recommended level of selection is high is inserted is displayed on a TV screen 50. Consequently, the user can be notified of the occurrence of the preset condition whose recommended level of selection is high before invoking the preset condition selection screen 40, take this opportunity to invoke the preset condition selection screen 40, and set the preset condition whose recommended level of selection is high as the valid preset condition. At this time, as described above, on the preset condition selection screen 40, the preset conditions 42 and 43 whose recommended level of selection is high are displayed to be distinguishable from other preset conditions by being displayed in different font color and font size, reversed display, italics, or the like, so the user can easily identify the preset conditions 42 and 43 whose recommended level of selection is high. Consequently, the user can select a preset condition to be made valid while recognizing the preset conditions 42 and 43 whose recommended level of selection is high.

Further, in this embodiment, the user's risk of overlooking the preset condition whose recommended level of selection is high is reduced, whereby the recording condition is effectively prevented from being filled with preset conditions under which the program hit rate is low when the setting number of preset conditions which can be made valid as the recording conditions is limited, thus enabling effective use of preset conditions.

Incidentally, in the above description on the processing of determining the preset condition whose recommended level of selection is high, the determination is made with programs of the EPG data within a single day as the object to be matched, but the present invention is not limited to this, and it is also possible to count the number of pieces of program information matching a preset condition within the limit of the previously set number of days, and when the value reaches a threshold value, determine this preset condition as the preset condition whose recommended level of selection is high. Alternatively, it is also possible to calculate the mean value of the numbers of pieces of program information matching a preset condition for the previously set number of days, and when this mean value reaches a threshold value, determine this preset condition as the preset condition whose recommended level of selection is high. Moreover, when the number of pieces of program information matching a preset condition is counted for a period of two days or more, it is desirable to count the number of pieces of program information for one week from Monday to Sunday such that the same program is not counted again as much as possible.

Further, by changing the count value according to the length of the program broadcast time and changing the count value according to the day of the week, a recommended level of selection with higher credibility can be expected to be obtained.

Matching processing methods carried out when retrieving a program matching the internal retrieval condition corresponding to the valid preset condition and when determining the preset condition whose recommended level of selection is high need not be necessarily the same. For example, when the preset condition whose recommended level of selection is high is determined, a program matching either the category or keyword of the internal retrieval condition may be determined as the program matching the preset condition.

It is to be understood that the present invention is not intended to be limited to the above embodiment, and various changes may be made without departing from the gist of the present invention.

What is claimed is:

1. A program recording apparatus, comprising:
an acquiring means for acquiring electronic program guide information;
a preset condition storage unit in which a plurality of preset conditions used for retrieving a program from the electronic program guide information acquired by the acquiring means are stored;
a determining means for determining a preset condition whose recommended level of selection is high out of the plurality of preset conditions stored in the preset condition storage unit on the basis of the electronic program guide information acquired by the acquiring means; and
a notifying means for notifying a user of the preset condition whose recommended level of selection is high determined by the determining means.

2. The program recording apparatus as set forth in claim 1,
wherein the determining means counts, with respect to the electronic program guide information acquired by the acquiring means, for each of the plurality of preset conditions stored in the preset condition storage unit, the number of programs matching the preset condition, and determines the preset condition as the preset condition whose recommended level of selection is high when the counted value reaches a predetermined value.

3. The program recording apparatus as set forth in claim 1, further comprising:
a selecting means for causing the user to select a desired preset condition from the plurality of preset conditions stored in the preset condition storage unit; and
a program retrieving means for retrieving a program matching the preset condition selected by the user via the selecting means from the electronic program guide information.

4. The program recording apparatus as set forth in claim 1,
wherein the determining means determines the preset condition whose recommended level of selection is high every time the electronic program guide information is newly acquired by the acquiring means.

5. The program recording apparatus as set forth in claim 1,
wherein the determining means determines the preset condition whose recommended level of selection is high on the basis of the electronic program guide information acquired by the acquiring means for a given period of time.

6. The program recording apparatus as set forth in claim 3,
wherein the notifying means distinguishably notifies the user of the preset condition whose recommended level of selection is high when the selecting means causes the user to select the desired preset condition from the plurality of preset conditions stored in the preset condition storage unit.

7. A preset condition processing method for a program recording apparatus provided with a preset condition storage unit in which a plurality of preset conditions used for retrieving a program from electronic program guide information are stored, comprising:
acquiring the electronic program guide information;
determining a preset condition whose recommended level of selection is high out of the plurality of preset conditions stored in the preset condition storage unit on the basis of the acquired electronic program guide information; and
notifying a user of the determined preset condition whose recommended level of selection is high.
